(19) United States
(12) Patent Application Publication
(10) Pub. No.: US 2024/0273270 A1
(43) Pub. Date: Aug. 15, 2024

(54) GENERATING LEARNED REPRESENTATIONS OF DIGITAL CIRCUIT DESIGNS

(71) Applicant: Google LLC, Mountain View, CA (US)

(72) Inventors: Shobha Vasudevan, Palo Alto, CA (US); Wenjie Jiang, Mountain View, CA (US); Charles Aloysius Sutton, Santa Clara, CA (US); Rishabh Singh, San Jose, CA (US); David Bieber, Mountain View, CA (US); Milad Olia Hashemi, San Francisco, CA (US); Chian-min Richard Ho, Palo Alto, CA (US); Hamid Shojaei, San Jose, CA (US)

(21) Appl. No.: 18/564,797

(22) PCT Filed: May 31, 2022
(86) PCT No.: PCT/US2022/031624

§ 371 Date: Nov. 28, 2023

Related U.S. Application Data
(60) Provisional application No. 63/194,934, filed on May 28, 2021.

(51) Int. Cl. G06F 30/323; G06F 30/33

(52) U.S. Cl. CPC G06F 30/323; G06F 30/33

(57) ABSTRACT

Methods, systems, and apparatus, including computer programs encoded on computer storage media, for generating learned representations of digital circuit designs. One of the systems includes obtaining data representing a program that implements a digital circuit design, the program comprising a plurality of statements; processing the obtained data to generate data representing a graph representing the digital circuit design, the graph comprising: a plurality of nodes representing respective statements of the program, a plurality of first edges each representing a control flow between a pair of statements of the program, and a plurality of second edges each representing a data flow between a pair of statements of the program; and generating a learned representation of the digital circuit design, comprising processing the data representing the graph using a graph neural network to generate a respective learned representation of each statement represented by a node of the graph.

### CROSS-REFERENCE TO RELATED APPLICATIONS

This application claims the benefit of priority under 35 U.S.C. § 119 to U.S. Provisional Application Ser. No. 63/194,934, filed May 28, 2021, the entirety of which is incorporated herein by reference.

### BACKGROUND

This specification relates to neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that is configured to process data representing the design of a digital circuit to generate a machine-learned representation of the design (or, equivalently, a machine-learned representation of digital circuits manufactured according to the design). The system can then process the learned representation of the digital circuit design using one or more prediction neural networks to generate respective predictions about the digital circuit design.

The subject matter described in this specification can be implemented in particular embodiments so as to realize one or more of the following advantages.

Using techniques described in this specification, a system can generate machine-learned representations of digital circuit designs, and use the machine-learned representations for multiple different downstream tasks. The machine-learned representations can encode information about the attributes of the digital circuit design as well as source code information from the program statements used to implement the circuit.

Existing systems that perform verification on a digital circuit designs can require different hand-designed tests for each new design, requiring hundreds or thousands of expert engineer-hours. Using some techniques described in this specification, a trained neural network can automatically generate new tests for a given digital circuit design.

Executing hand-designed tests can require significant time and computational costs, sometimes taking multiple hours or days to do a single suite of tests. Using some techniques described in this specification, a system can predict, with high accuracy, the outcome of a particular test significantly more quickly. For example, in some implementations, generating a prediction for the outcome of a test only requires a single forward pass through the trained neural network, which can take, e.g., a few seconds or a fraction of a second. Providing instant feedback to engineers of the digital circuit design can significantly improve the efficiency of the process of designing a new circuit, allowing the engineers to test more designs and iterate much more quickly.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example neural network system that is configured to generate a learned representation of a digital circuit design.

FIG. 2 illustrates an example graph determined from a digital circuit design.

FIG. 3 is a flow diagram of an example process for generating a learned representation of a digital circuit design.

FIG. 4 is a flow diagram of an example process for using a learned representations of a digital circuit design to predict coverage.

FIG. 5 is a flow diagram of an example process for using a learned representations of a digital circuit design to generate new test inputs.

Like reference numbers and designations in the various drawings indicate like elements.

### DETAILED DESCRIPTION

This specification describes a system implemented as computer programs on one or more computers in one or more locations that is configured to generate synthetic images using a self-attention based neural network.

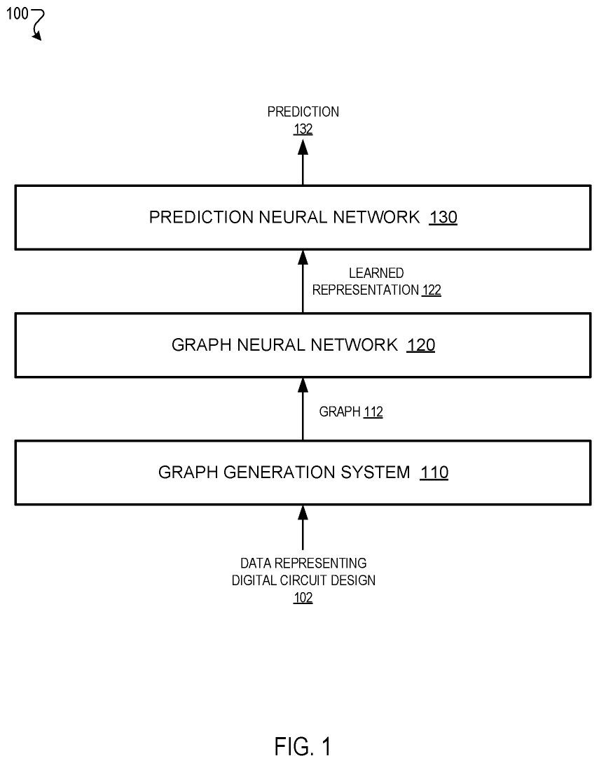

FIG. 1 is a diagram of an example neural network system 100 that is configured to generate a learned representation 122 of a digital circuit design 102. The neural network system 100 is an example of a system implemented as computer programs on one or more computers in one or more locations, in which the systems, components, and techniques described below can be implemented.

The neural network system 100 includes a graph generation system 110, a graph neural network 120, and a prediction neural network 130.

The graph generation system 110 is configured to process data representing the digital circuit design 102 to generate a graph 112 that represents the digital circuit design 102. The graph 112 can include (i) multiple nodes each representing a respective component of the digital circuit design, and (ii) multiple edges that each connect a respective pair of nodes and that each represent a connection between the respective components of the digital circuit design represented by the pair of nodes.

The graph neural network 120 is configured to process data representing the graph 112 to generate the learned representation 122 of the digital circuit design 102. The learned representation 122 can include, for each component of the digital circuit design 102 represented by a respective node of the graph, an updated representation of the component generated by the graph neural network 120.

The prediction neural network 130 is configured to process the learned representation 122 of the digital circuit design 102 to generate a prediction 132 about the digital circuit design. Example prediction tasks that can be performed using the learned representation 122 of the digital circuit design 102 are discussed below.

The digital circuit design 102 can be a design for any appropriate type of digital circuit. As a particular example, the digital circuit design 102 can be a design for a reduced instruction set computer (RISC) digital circuit, e.g., a digital circuit having a RISK-V architecture such as an IBEX digital circuit. In some implementations, the digital circuit design 102 represents a design for a special-purpose digital circuit, i.e., a digital circuit designed to execute a particular type of task. For example, the digital circuit can be designed specifically to execute machine learning tasks, e.g., the digital circuit can be a tensor processing unit (TPU) or a different ASIC that is designed to accelerate machine learning computations in hardware.

The neural network system 100 can be configured to receive any appropriate type of data that represents the digital circuit design 102. For example, the neural network system 100 can receive the source code for a program that implements the digital circuit design 102. For example, the source code can be written in a hardware description language, such as Verilog or VHSIC Hardware Description Language (VHDL). As another example, instead of or in addition to receiving source code representing the digital circuit design 102, the neural network system 100 can receive data representing an abstract syntax tree (AST) of the source code. As another example, instead of or in addition to receiving the source code and/or the AST representing the digital circuit design 102, the neural network system 100 can receive data representing a gate level netlist representing the digital circuit design 102.

The data representing the digital circuit design 102 can be a representation at any appropriate abstraction level, e.g., the register-transfer level (RTL) or the gate level of abstraction.

In some implementations, the neural network system 100 can be configured to process data representing only a portion of a digital circuit design 102 and to generate a learned representation 112 of the portion of the digital circuit design 102. For example, the neural network system 100 can be configured to generate a learned representation 112 of a strict subset of the modules of the digital circuit design 102, or any appropriate subcircuit of the digital circuit design. Although the below description generally refers to generating learned representations of full digital circuit designs, it is to be understood that the same techniques can be applied to generate learned representations of respective portions of digital circuit designs, e.g., by generating graphs 112 representing the portions of the digital circuit designs.

As mentioned above, the graph generation system 110 is configured to process data representing the digital circuit design 102 to generate a graph 112 that represents the digital circuit design 102.

For example, if the neural network system 100 is configured to receive data representing the digital circuit design 102 at the gate level, then the graph generation system 110 can process the data to generate a gate-level state transition graph 112 representing the digital circuit design 102, where each node of the gate-level state transition graph 112 corresponds to single value of the bit-level state of the registers of the digital circuit design, and each edge of the gate-level state transition graph 112 represents a legal change in state that the digital circuit can make in a single clock cycle. That is, an edge between a first node and a second node representing respective values for the full state of the registers can represent a transition from the state represented by the first node to the state represented by the second node, where the digital circuit can change from the state represented by the first node to the state represented by the second node in a single clock cycle of the digital circuit.

As another example, if the neural network system 100 is configured to receive data representing the digital circuit design 102 at the register-transfer level (e.g., if the neural network system 100 receives RTL source code for the digital circuit design 102), then the graph generation system 110 can process the data to generate a control data flow graph (CDFG) 112 representing the digital circuit design 102.

Although the below description generally refers to generating a processing a graph 112 that is a CDFG representing the digital circuit design 102 at the register-transfer level, it is to be understood that the same techniques can be applied using any appropriate representation of the digital circuit design 102.

One or more nodes of the graph 112 can represent one or more respective statements in the source code for the digital circuit design 102. In some implementations, each node in the graph 112 represents one or more respective statements. That is, each node in the graph 112 can represent a single statement of the source code or a sequence of multiple statements of the source code, e.g., a particular path within the source code that would be traversed given a particular input to a digital circuit manufactured according to the digital circuit design 102. In some other implementations, the graph 112 can include one or more nodes that do not represent statements of the source code representation of the digital circuit design 102.

Although the below description generally refers to implementations in which each node of the graph 112 represents a single statement from the source code of the digital circuit design 102, it is to be understood that the same techniques can be applied in implementations in which at least some nodes of the graph 112 represent multiple statements, e.g., multiple consecutive statements within the source code.

The graph 112 can include one or more edges, called “control” edges, that represent control flow between respective pairs of statements in the source code of the digital circuit design 102. That is, a control edge from a first node to a second node represents a control flow between the statement represented by the first node and the statement represented by the second node, i.e., where the output of the statement represented by the first node can either trigger or not trigger the execution of the statement represented by the second node. Control edges are sometimes called “first” edges herein.

The graph 112 can include one or more edges, called “data” edges, that represent data flow between respective pairs of statements in the source code of the digital circuit design 102. That is, a data edge from a first node to a second node represents a data flow between the statement represented by the first node to the statement represented by the second node, i.e., where a variable whose value is generated by the statement represented by the first node is used by the statement represented by the second node.

Typically, each edge in the graph 112 is a directed edge, i.e., encodes a directionality (e.g., a direction of control flow or data flow) from one “parent” node to another “child” node.

In some implementations, each edge in the graph 112 is either a control edge or a data edge. In some other implementations, the graph 112 can include one or more edges that do not represent either control flow or data flow within the source code representation of the digital circuit design 102. For example, one or more edges of the graph 112 can encode information about the expected time taken to execute a respective statement in hardware, and/or one information about the expected power consumption of executing a respective statement in hardware.

The graph generation system 110 can generate an initial embedding for each node in the graph using data representing the statement of the source code of the digital circuit design 102 represented by the node. In this specification, an embedding is an ordered collection of numeric values that represents an input in a particular embedding space. For example, an embedding can be a vector of floating point or other numeric values that has a fixed dimensionality.

For example, for each node of the graph 112, the graph generation system 110 can generate the initial embedding for the node from a set of attributes describing the statement represented by the node. The attributes can be provided to the neural network system 100 with the data representing the digital circuit design 102, or the graph generation system 110 can determine the attributes by processing the data representing the digital circuit design 102 (e.g., by processing the source code). For example, the set of attributes can include one or more of: an identifier identifying the node (e.g., a unique numeric value assigned to the node); a node type of the node; fan-in data such as a number or type of parent nodes of the node; fan-out data such as a number or type of child nodes of the node; a condition represented by the node, e.g., if the node has the control node type described below; whether the node represents the start of an always block; an identification of a path in the graph 121 to which the node belongs; an identification of an assertion, property, or output that is influenced by the statement represented by the node; an identification of a pipeline stage of the statement represented by the node; or an identification of one or more signals on the sensitivity list of the statement represented by the node. As a particular example, the graph generation system can concatenate the set of attributes to generate an attribute vector, and determine the initial embedding to be the attribute vector or determine the initial embedding from the attribute vector.

As particular examples, the node types of respective nodes of the graph 112 can include one or more of: an operation node type, where nodes having the operation node type represent statements in the source code that process data, e.g., statements that represent arithmetic, logical, relational, or complex functions, or module instantiations; a control node type, where nodes having the control node type represent statements in the source code that are conditional decisions, e.g., branches, loops, or cases; or a storage node type, where nodes having the storage node type represent statements in the source code that instantiate or update variables or signals that are read from or written to by respective operations.

As another example, for each node of the graph 112, the graph generation system 110 can generate the initial embedding for the node by processing the portion of the source code corresponding to the statement represented by the node. For example, the graph generation system 110 can identify a sequence of tokens representing the statement, e.g., where each token represents a word or character of the source code. The graph generation system 110 can combine the tokens in the sequence to generate a combined representation of the sequence of tokens, and determine the initial embedding to be the combined representation or determine the initial embedding from the combined representation.

As a particular example, the graph generation system 110 can determine the combined representation to be a mean of the tokens. As another particular example, the graph generation system 110 can determine the combined representation by processing the sequence of tokens using a pooling function, e.g., max pooling or mean pooling. As another particular example, the graph generation system 110 can generate the combined representation by processing the sequence of tokens using a recurrent neural network, e.g., a long short-term memory network (LSTM). That is, the graph generation system 110 can determine a combined representation ϕ(sⁿ) for each node n by computing:

$$\\ ϕ ( {s}^{{}_{} n} ) = LSTM ( < {s}_{1}^{{}_{} n} , {s}_{2}^{{}_{} n} , … , {s}_{k}^{{}_{} n} > )$$

where sⁿ= [symbol] , s₁ⁿ, s₂ⁿ, . . . , sₖⁿ [symbol] is the sequence of tokens representing the statement corresponding to the node.

In some implementations, for each node of the graph 112, the graph generation system 110 can generate the initial embedding by combining, e.g., through concatenation, (i) the set of attributes of the statement corresponding to the node and (ii) the combined representation of the sequence of tokens representing the statement corresponding to the node. That is, the graph generation system can generate an initial embedding ϕ⁽⁰⁾(n) for each node n by computing

$$\\ {ϕ}^{{}_{} ( 0 )} ( n ) = Concat ( < ϕ ( {s}^{{}_{} n} ) , {f}_{1}^{{}_{} n} , … , {f}_{l}^{{}_{} n} > )$$

where each fⱼⁿ is an attribute of the statement corresponding to the node.

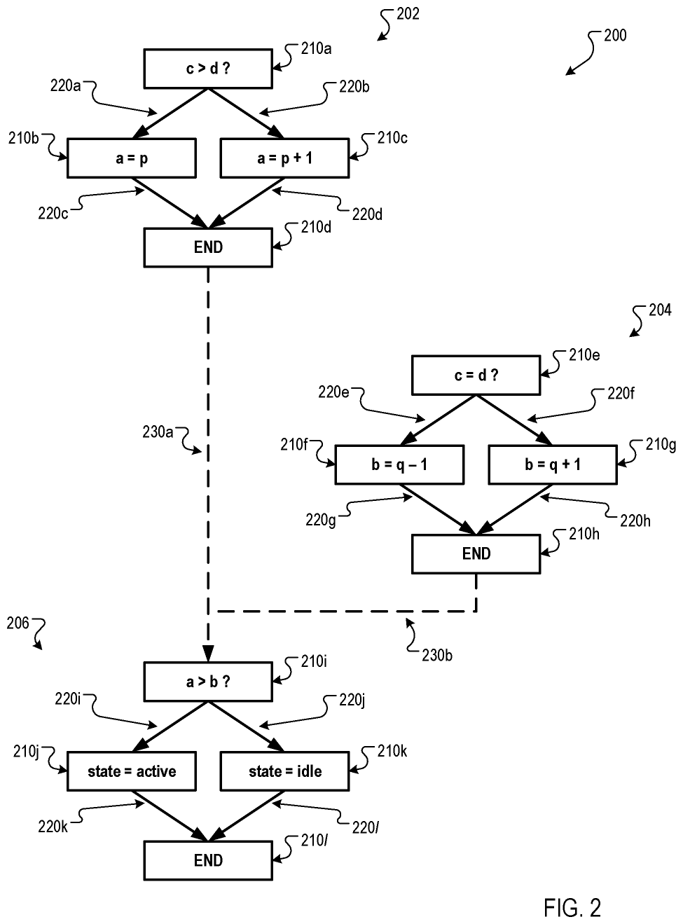

An example graph representing a digital circuit design is discussed in more detail below with reference to FIG. 2

In some implementations, an external system is configured to process the data representation the digital circuit design 102 to generate the graph 112, and provide data representing the graph 112 to the neural network system 100. That is, in some implementations, the neural network system 100 does not include the graph generation system 110, but rather receives the graph 112 from an external system.

The graph neural network 120 can process the graph 112 to generate the learned representation 122 of the digital circuit design 102. In particular, at each of multiple stages of the execution of the graph neural network 120, the graph neural network 120 can update the respective embedding for each node of the graph 112. Then, after the final stage, the graph neural network 120 can output a learned representation 122 of the digital circuit design that includes, for each node in the graph corresponding to a respective statement, a final embedding for the node (which can be considered an embedding of the statement). That is, the learned representation 122 can be wholly or partially composed of respective embeddings for each statement in the source code of the digital circuit design 102.

That is, at each stage t of the graph neural network 120, the current representation ψ^{(t)} of the digital circuit 102 can be given by:

$$\\ {ψ}^{{}_{} ( t )} ( G ) = \{ {ϕ}^{{}_{} ( t )} ( n ) \vert ∀ n ∈ N \}$$

where G represents the graph 112 and N is the total number of nodes in the graph 112.

At each stage t, the graph neural network 120 can update the current representation ψ^{(t)} of the digital circuit 102 by computing:

$$\\ {ψ}^{{}_{} ( t + 1 )} ( G ) = {f}_{θ} ( {ψ}^{{}_{} ( t )} ( G ) )$$

Where f_{θ} represents the operations of the graph neural network 120 having learned network parameters θ.

The graph neural network 120 can have any appropriate configuration for updating the embeddings for the nodes of the graph 112. Example graph neural networks that are configured to generate learned representations of digital circuit designs are discussed below with reference to FIG. 2.

In some implementations, the graph neural network 120 determines to end execution after a predetermined number T of stages. In some other implementations, the graph neural network 120 determines, after each stage, whether to end execution according to whether one or more conditions have been satisfied. For example, after each stage t, the graph neural network 120 can determine a degree to which the current embeddings ϕ^{(t)}(n) for the nodes n were updated during the stage, e.g., an average difference, across all nodes n, between ϕ^{(t-1)}(n) and ϕ^{(t)}(n). If the average difference is below a predetermined threshold, then the graph neural network 120 can determine to end execution and output the current representation ψ^{(t)} of the digital circuit 102 as the final learned representation 122.

As mentioned above, the prediction neural network 130 can process the learned representation 122 of the digital circuit design to generate a prediction 132 about the digital circuit design 102.

In some implementations, after the graph neural network 120 generates the learned representation 122 of the digital circuit design 102, the neural network system 100 provides the learned representation 122 directly to the prediction neural network 130.

In some other implementations, after the graph neural network 120 generates the learned representation 122 of the digital circuit design 102, the neural network system 100 stores the learned representation 122 in a data store for later use. Then, at a future time, the prediction neural network 130 can obtain the learned representation 112 from the data store and process the learned representation 122 to generate the prediction 132. That is, although the graph neural network 120 is depicted in FIG. 1 as providing the learned representation 122 directly to the prediction neural network 130, in some implementations the graph neural network 120 and the prediction neural network 130 can execute asynchronously. For example, at a first time point the neural network system 100 can generate the learned representation 122 of the digital circuit design 102, and then at multiple future time points a respective prediction neural network can use the learned representation 122 to generate a prediction 132 about the digital circuit design 102.

In some implementations, the learned representation 122 can be used by multiple different prediction neural networks 130 that are each configured to perform a respective different machine learning task using the learned representation 122. That is, the graph neural network 120 can be configured through training to encode information about the digital circuit design 102 into the learned representation 122 that can be leveraged to perform multiple different prediction tasks.

The prediction neural network 130 can be configured through training to generate any appropriate prediction 130 about the digital circuit design 102. For example, the prediction neural network 130 can be configured to detect bugs in the digital circuit design 102; as a particular example, the prediction 132 can include an identification of one or more statements or blocks of statements in the digital circuit design 102 that are likely to execute differently than intended. As another example, the prediction 132 can include data characterizing one or more desirable properties or assertions of the digital circuit design 102; as a particular example, the prediction neural network 130 can be configured to perform formal verification on the digital circuit design 102.

As another example, the prediction neural network 130 can be configured to perform hardware verification of the digital circuit design 102, e.g. as part of an industrial hardware design cycle. That is, the prediction 132 about the digital circuit design 102 can be a prediction of whether a particular test input to a digital circuit manufactured according to the digital circuit design 102 will cause a particular coverage point to be covered. A coverage point (or simply cover point) is a sequence of statements of the source code of the digital circuit design 102 (or, equivalently, a sequence of nodes in the graph 112). If a particular test input to the digital circuit design 102 causes each statement in the sequence to be executed, then the particular test input is said to “cover” the coverage point. In this example, the network input for the prediction neural network 130 can include (i) the learned representation 122 of the digital circuit design 102, (ii) an identification of the coverage point and (ii) an identification of a test input.

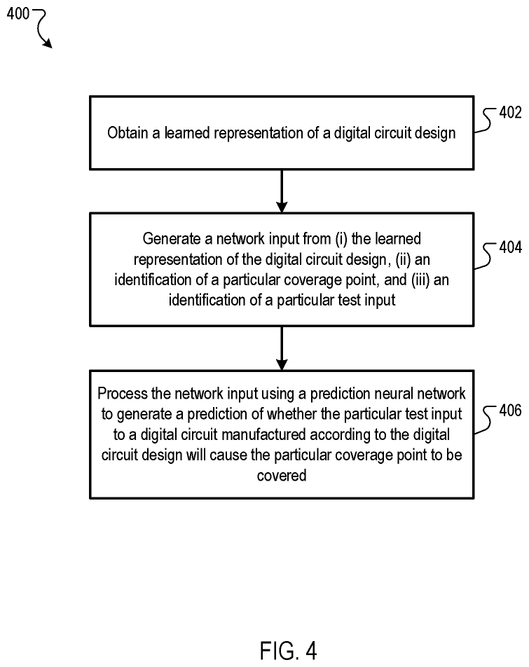

Example techniques for performing verification using a learned representation of a digital circuit design are discussed in more detail below with reference to FIG. 4.

As another example, the prediction neural network 130 can be configured to generate a new test input that is predicted to cover a particular desired coverage point (or a set of multiple desired coverage points).

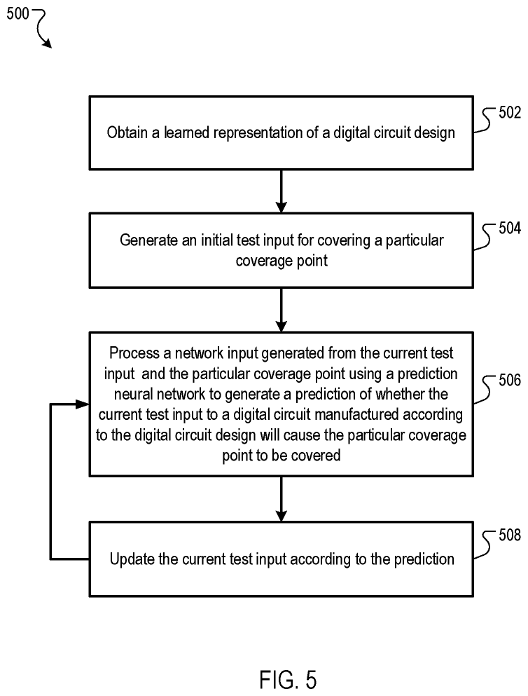

Example techniques for generating new test inputs using a learned representation of a digital circuit design are discussed in more detail below with reference to FIG. 5.

In other words, the neural network system 100 can be a component of a software that is configured to perform verification of digital circuit designs. That is, users can generate new designs for digital circuits and use the software to verify whether the design satisfies a set of requirements. For example, the neural network system 100 can be made available to digital circuit engineers or other users through an application programming interface (API), or can be a portion of a software application that runs on a user device.

As another example, the prediction neural network 130 can be configured to predict, given a particular test input (or distribution over test inputs), respective values that one or more variables will have after a digital circuit manufactured according to the digital circuit design 102 processes the particular test input. As another example, the prediction neural network 130 can be configured to generate constraints for test inputs that are predicted to cover particular desired coverage points.

The graph neural network 120 and the prediction neural network 130 can be trained using any appropriate technique.

In some implementations, the graph neural network 120 and the prediction neural network 130 are trained concurrently, end-to-end. For example, a training system can process, from a training data set of training digital circuit designs, a training digital circuit design to using the neural network system 100 to generate a prediction about the training digital circuit design. The training system can determine an error in the prediction about the training digital circuit design, and backpropagate the error through both the prediction neural network 130 and the graph neural network 120 to determine a parameter update to the network parameters of the neural networks 130 and 120, e.g., using gradient descent. In some implementations in which the graph generation system 110 includes one or more neural network layers (e.g., the recurrent neural network layers configured to generate the initial representation for each node in the graph 112 as described above), the training system can further train the neural network layers of the graph generation system 110 concurrently with the graph neural network 120 and the prediction neural network 130.

In some other implementations, a training system first trains the graph neural network 120 using a first prediction task (e.g., the verification or test generation tasks described above) to determine trained values for the network parameters of the graph neural network 120 (and, optionally, any neural network layers in the graph generation system 110). The training system can then use the trained graph neural network 120 to generate learned representations 122, and use the learned representations to train the prediction neural network 130 on a second prediction task to determine trained values for the network parameters of the prediction neural network 130 (optionally fine-tuning, i.e., updating, the values for the network parameters of the graph neural network 120).

The training system can train one or more of the graph neural network 120 or the prediction neural network 130 using training examples that include (i) training digital circuit designs and (ii) ground-truth outputs for a particular prediction task, e.g., coverage information describing how respective coverage points of the training digital circuit designs are covered. For example, for each training digital circuit design, the training system can generate one or more random test inputs and, for each test input, use a simulator (e.g., a Verilog simulator) to generate ground-truth labels of whether a particular coverage point is covered by the test input.

The training system can use any appropriate loss function. As a particular example, the training system can determine the errors in the predictions generated by the neural network system 100 during training using a binary cross entropy loss function.

A user of the neural network system 100, e.g., an engineer working on designing a new digital circuit, can thus provide different respective designs 102 for the new digital circuit to the neural network system 100 for analysis. For example, the user can use the neural network system 100 to predict whether a particular design appropriately covers a particular coverage point. In response to a prediction 132 generated the prediction neural network 130, the user (or an external automated system) can determine to update the design 102 of the new digital circuit. For example, the user can determine, in response to the prediction neural network 130 predicting that a particular coverage point cannot be covered using any test input, to update the design 102 of the new digital circuit so that the updated design 102 can cover the particular coverage point for a certain test input. As another example, an automated system can be configured to repeatedly send designs 102 to the neural network system 100 and, if the prediction neural network 130 generates a prediction that the current design 102 fails one or more criteria, update the design 102, e.g., using an evolutionary technique that incrementally updates the design 102, e.g., according to one or more predetermined heuristics.

After determining, according to the predictions 132 generated by the prediction neural network 130, that a particular design 102 satisfies all criteria, the user or external system can determine to finalize the digital circuit design 102. The finalized digital circuit design 102 can then be provided to a manufacturing system for manufacturing digital circuits according to the design 102, i.e., manufacturing digital circuits that have an architecture defined by the design 102. The manufactured digital circuits can then be deployed on respective electronic devices, e.g., on cloud computing hardware or on user devices such as mobile phones or laptops.

FIG. 2 illustrates an example graph 200 determined from a digital circuit design.

For example, the graph 200 can be generated by a graph generation system of a neural network system configured to generate learned representations of digital circuit designs, e.g., the graph generation system 110 of the neural network system 100 described above with reference to FIG. 1.

The graph 200 can be generated from source code that implements the digital circuit design, e.g., source code written in a hardware description language as described above.

The graph 200 includes (i) a set of nodes 210a-l that each represent a respective statement of the source code of the digital circuit design, (ii) a set of control edges 220a-1 (depicted as solid lines in FIG. 2) that each represent a control flow between respective statements, and (iii) a set of data edges 230a-b (depicted as dashed lines in FIG. 2) that each represent a data flow between respective statements.

The graph 200 includes three sub-graphs 202, 204, and 206 that each represent a respective block of statements of the source code of the digital circuit design. In particular, the sub-graphs 202, 204, and 206 each represent “always” blocks that repeatedly execute when a digital circuit manufactured using the digital circuit design executes.

The always blocks represented by the sub-graphs 202, 204, and 206 can execute in parallel. In particular, at each clock cycle of the execution of the digital circuit, an external clock signal can trigger, for each always block, execution of a respective statement. The statements in each always block are therefore executed in sequence over multiple consecutive clock cycles. When executing a statement, the input values of respective variables of the digital circuit in the current cycle come from the output values of the respective variables from the previous cycle.

For each sub-graph 202, 204, and 206 of the graph 200, the graph 200 can include an control edge from the final node in the sub-graph (i.e., node 210d in the first sub-graph 202, node 210h in the second sub-graph 204, and node 210l in the third sub-graph 206) to the first node in the sub-graph (i.e., node 210a in the first sub-graph 202, node 210e in the second sub-graph 204, and node 210i in the third sub-graph 206), representing the cyclic execution of the always blocks.

The source code corresponding to the nodes of the sub-graph 202 is reproduced below:

```
always@(*)
if (c > d)
  a = p;
else
  a = p + 1;
```

The first node 210a in the sub-graph 202 represents the “if” statement.

If the variable c is greater than the variable d, then the control edge 220a is followed to the node 210b, and the statement corresponding to the node 210b is executed. The control edge 220c is then followed to the final node 210d in the sub-graph 202, which represents the end of the always block.

If the variable c is not greater than the variable d, then the control edge 220b is followed to the node 210c, and the statement corresponding to the node 210c is executed. The control edge 220d is then followed to the final node 210d in the sub-graph 202.

The source code corresponding to the nodes of the sub-graph 204 is reproduced below:

```
always@(*)
if (c = d)
  b = q − 1;
else
  b = q + 1;
```

The first node 210e in the sub-graph 204 represents the “if” statement.

If the variable c is equal to the variable d, then the control edge 220e is followed to the node 210f, and the statement corresponding to the node 210f is executed. The control edge 220g is then followed to the final node 210h in the sub-graph 204, which represents the end of the always block.

If the variable c is not equal to the variable d, then the control edge 220f is followed to the node 210g, and the statement corresponding to the node 210g is executed. The control edge 220h is then followed to the final node 210d in the sub-graph 204.

The source code corresponding to the nodes of the sub-graph 206 is reproduced below:

```
always@(*)
if (a > b)
  state = active;
else
  state = idle;
```

The first node 210i in the sub-graph 206 represents the “if” statement. Because the “if” statement depends on the values of the variables a and b, which are generated by respective nodes of the sub-graphs 202 and 204, the graph 200 includes a data edge 230a between the final node 210d of the sub-graph 202 to the first node 210i of the sub-graph 206, and a data edge 230b between the final node 210h of the sub-graph 204 and the first node 210i of the sub-graph 206.

If the variable a is greater than the variable b, then the control edge 220i is followed to the node 210j, and the statement corresponding to the node 210j is executed; namely a state variable of the digital circuit is set to “active.” The control edge 220k is then followed to the final node 210l in the sub-graph 206, which represents the end of the always block.

If the variable a is not greater than the variable b, then the control edge 220j is followed to the node 210k, and the statement corresponding to the node 210k is executed; namely, the state variable of the digital circuit is set to “idle.” The control edge 220l is then followed to the final node 210l in the sub-graph 206.

Respective embeddings for each of the nodes 210a-l can be updated by a graph neural network at each of multiple stages to generate a learned representation of the digital circuit design that includes respective final embeddings for each of the nodes 210a-l. For example, the graph neural network 120 described above with reference to FIG. 1 can process data representing the graph 200 to generate a learned representation of the digital circuit design.

The graph neural network configured to process the graph 200 can have any appropriate configuration. For example, the graph neural network can be a graph convolutional network (GCN), e.g., as described in “Semi-Supervised Classification with Graph Convolutional Networks,” Kipf et al., arxiv: 1609.02907. As another example, the graph neural network can be a gated graph neural network, e.g., as described in “Gated Graph Sequence Neural Networks,” Li et al., arXiv: 1511.05493. As another example, the graph neural network can be a graph neural network multilayer perception (GNN-MLP), e.g., as described in “GNN-FiLM: Graph Neural Networks with Feature-wise Linear Modulation,” Marc Brockschmidt, arXiv: 1906.12192.

As another example, the graph neural network can be an instruction pointer attention graph neural network (IPA-GNN), e.g., as described in “Learning to Execute Programs with Instruction Pointer Attention Graph Neural Networks,” Bieber et al., arXiv: 2010.12621, the entire contents of which are hereby incorporated by reference.

In some implementations in which the graph neural network is an IPA-GNN, the graph neural network can maintain multiple different instruction pointers (instead of a single instruction pointer), e.g., a respective instruction pointer for each “always” block in the source code of the digital circuit design. For example, before the first stage, the graph neural network 120 can instantiate a soft instruction pointer p_{t,n} as:

$$\\ {p}_{0 , n} = {1}_{n is an always block start node}$$

At each stage t, the graph neural network 120 can compute a hidden state proposal as:

$$\\ {a}_{i , n}^{{}_{} ( 1 )} = Dense ( {h}_{t - 1 , n} )$$

where “Dense” represents a sequence of one or more feedforward neural network layers.

In some implementations in which the graph neural network 120 is an IPA-GNN, the graph neural network can process graphs generated from digital circuit designs that include switch statements (instead of only binary conditions). For example, at each stage t, the graph neural network can compute a soft branch decision as:

$$\\ {b}_{t , n , m} = softmax ( Dense ( {h}_{t - 1 , n} ) \cdot Embed ( {e}_{n , m} ) )$$

where m∈Nₒᵤₜ(xₙ) is a control node child of node xₙ, i.e., a child of node xₙ via a control edge; and Embed(e_{n,m}) is an embedding for the control edge from xₙ to xₘ. The embedding can include or be generated from one or more of: an embedding of whether the condition is positive or negative, a first variable referenced by the condition, or a form of the condition.

In some implementations in which the graph neural network is an IPA-GNN, the graph neural network can model the propagation of messages between nodes (corresponding to respective statements) along data edges at each stage t. For example, the graph neural network can determine, for each particular node, a hidden state proposal from one or more of (i) control node state proposals (e.g., from nodes that are within the particular node's always block) or (ii) proposals of other parent nodes (e.g., from nodes that are in a different always block). As a particular example, the graph neural network can compute the hidden state proposal for each node n at stage t as:

$$\\ {h}_{t , n}^{{}_{} ′} = {\sum }_{{n}^{{}_{} ′} ∈ {N}_{m} ( n ) ⋂ {N}_{ctrl}} {p}_{l - 1 , {n}^{{}_{} ′}} \cdot {b}_{t , {n}^{{}_{} ′} , n} \cdot {a}_{t , {n}^{{}_{} ′}}^{{}_{} ( 1 )} + {\sum }_{{n}^{{}_{} ′} ∈ {N}_{io} ( n ) ⋂ {\overline{N}}_{ctrl}} {a}_{i , {n}^{{}_{} ′}}^{{}_{} ( 1 )}$$

where N_{ctrl}⊆N identifies the set of control nodes in the graph.

In some implementations in which the graph neural network is an IPA-GNN, the graph can include an explicit or implicit edge, for each always blocks, from (i) the final (or “sink”) node in the always blocks and (ii) the first (or “root”) node in the always block, thus modelling non-termination.

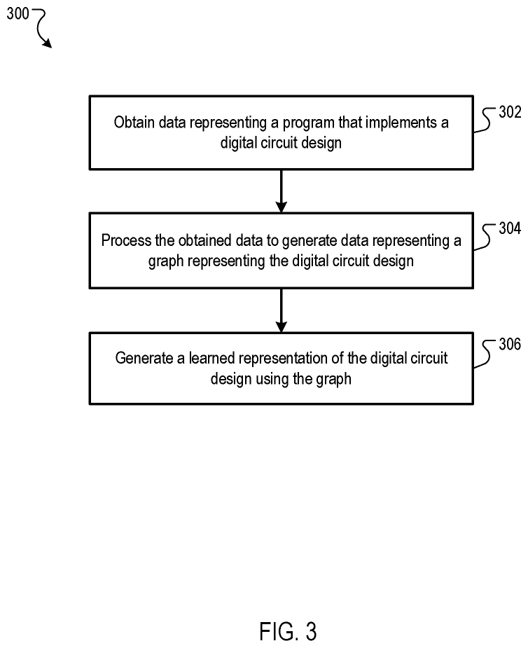

FIG. 3 is a flow diagram of an example process 300 for generating a learned representation of a digital circuit design. For convenience, the process 300 will be described as being performed by a system of one or more computers located in one or more locations. For example, a neural network system, e.g., the neural network system 100 described above with reference to in FIG. 1, appropriately programmed in accordance with this specification, can perform the process 300.

The system obtains data representing a program that implements the digital circuit design (step 302). The program can include a set of multiple statements.

The system processes the obtained data to generate data representing a graph representing the digital circuit design (step 304). The graph can include: (i) a set of multiple nodes representing respective statements of the program, (ii) a set of multiple first edges (i.e., control edges), and (iii) a set of multiple second edges (i.e., data edges). Each first edge is between a respective pair of nodes of the set of nodes and represents a control flow between a pair of statements of the program that are represented by the respective pair of nodes. Each second edge is between a respective pair of nodes of the set of nodes and represents a data flow between a pair of statements of the program that are represented by the respective pair of nodes.

The system generates the learned representation of the digital circuit design using the graph (step 306). In particular, the system can process the data representing the graph using a graph neural network to generate a respective learned representation of each statement represented by a node of the graph. Collectively, the learned representations of the statements can represent the learned representation of the digital circuit design.

FIG. 4 is a flow diagram of an example process 400 for using a learned representations of a digital circuit design to predict coverage. For convenience, the process 400 will be described as being performed by a system of one or more computers located in one or more locations. For example, a neural network system, e.g., the neural network system 100 described above with reference to in FIG. 1, appropriately programmed in accordance with this specification, can perform the process 400.

In particular, the system can generate a prediction of whether a particular coverage point will be covered by a digital circuit manufactured according to the digital circuit design in response to processing a particular test input.

The particular coverage point includes a sequence of one or more statements of a source code that implements the digital circuit design.

The particular test input can identify, for each of one or more variables of the digital circuit design, a particular value or range of values for the variable. Each variable can, e.g., be a Boolean variable, an integer variable, or a categorical variable.

The system obtains a learned representation of a digital circuit design (step 402). The learned representation can be generated by a graph neural network of the neural network system in response to processing a graph representing the digital circuit design, e.g., the graph neural network 120 described above with reference to FIG. 1.

The system generates a network input from (i) the learned representation of the digital circuit design, (ii) an identification of the particular cover point, and (iii) an identification of the particular test input (step 404).

For example, the system can generate a first network input from the learned representation that represents the coverage point. As described above learned representation of the digital circuit design can include a respective learned representation of each statement in the source code of the digital circuit design. Thus, the first network input can be generated from the learned representations of the statements in the particular coverage point.

For example, the system can generate a bitmask that is to be applied to the complete set of learned representations of respective statements, where the bitmask masks (i.e., removes) all learned representations in the set except for the learned representations of the statements of the coverage point. The system can apply the generated bitmask to identify the statements of the particular coverage point C:

$$\\ C = < {n}_{1} , {n}_{2} , … , {n}_{m} >$$

where m is the number of statements in the particular coverage point and each nᵢ represents the i^{th} statement in the particular coverage point.

The system can process the respective learned representations of the statements in C to generate the first network input. For example, the system can determine the first network to be a concatenation or sum of the m learned representations ϕ(nᵢ). As another example, the system can process the m learned representations ϕ(nᵢ) using one or more recurrent neural network layers, e.g., LSTM neural network layers, to generate the first network input. That is, the system can compute the first network input ϕ^{(T)}(C) to be:

$$\\ {ϕ}^{{}_{} ( T )} ( C ) = LSTM ( < {ϕ}^{{}_{} ( T )} ( {n}_{1} ) , {ϕ}^{{}_{} ( T )} ( {n}_{2} ) , … , {ϕ}^{{}_{} ( T )} ( {n}_{m} ) > )$$

The system can also generate a second network input that represents the particular test input. For example, the system can determine a concatenation of the j respective values iⱼ for the parameters I of the particular test input, and process the concatenated values using one or more neural network layers, e.g., using one or more feedforward neural network layers. That is, the system can compute the second network input ϕ(I) to be:

$$\\ ϕ ( I ) = MLP ( Concat ( {i}_{1} , … , {i}_{p} ) )$$

where MLP represents a multi-layer perceptron.

The system can then generate the network input by combining the first network input and the second network input, e.g., by determining a sum or concatenation of the first network input and the second network input.

The neural network layers used to generate the network input can be considered to be a component of the prediction neural network described below.

The system processes the network input using a prediction neural network to generate a prediction of whether the particular test input to the digital circuit manufactured according to the digital circuit design will cause the particular coverage point to be covered (step 406). For example, the prediction neural network can be the prediction neural network 130 described above with reference to FIG. 1.

For example, the output of the prediction neural network can be a likelihood value, e.g., a value between 0 and 1, that represents a likelihood that the test would cover the coverage point.

As a particular example, the prediction neural network can include one or more feedforward neural network layers. That is, the system can compute:

$$\\ is\_hit ( C , I ) = {MLP}_{σ} ( Concat ( {ϕ}^{{}_{} ( T )} ( C ) , ϕ ( I ) ) )$$

where is_hit(C, I) identifies the likelihood value.

FIG. 5 is a flow diagram of an example process 500 for using a learned representations of a digital circuit design to generate new test inputs. For convenience, the process 500 will be described as being performed by a system of one or more computers located in one or more locations. For example, a neural network system, e.g., the neural network system 100 described above with reference to in FIG. 1, appropriately programmed in accordance with this specification, can perform the process 500.

In particular, the system can generate a new test input that is predicted to provide coverage of a particular coverage point in a digital circuit manufactured according to the digital circuit design.

The particular coverage point includes a sequence of one or more statements of a source code that implements the digital circuit design.

The new test input can identify, for each of one or more variables of the digital circuit design, a particular value or range of values for the variable. Each variable can, e.g., be a Boolean variable, an integer variable, or a categorical variable.

The system can generate the new test input using gradient search. The system can perform the gradient search using a prediction neural network that has been pre-trained on a different prediction task, e.g., the coverage prediction task described above with reference to FIG. 1 and FIG. 4. That is, the same prediction neural network can be configured to perform both the process 500 and the process 400 described above with reference to FIG. 4.

The system obtains a learned representation of a digital circuit design (step 502). The learned representation can be generated by a graph neural network of the neural network system in response to processing a graph representing the digital circuit design, e.g., the graph neural network 120 described above with reference to FIG. 1.

The system generates an initial test input for covering the particular coverage point (step 504). For example, the system can randomly generate the initial test input. As another example, the system can select an initial test input that is known (e.g., from previous executions of the prediction neural network) to cover a different coverage point that is similar to or local to the particular coverage point (e.g., another coverage point in the same block of the source code that implements the digital circuit design).

The system processes a network input generated from the initial test input and the particular coverage point using the prediction neural network to generate a prediction of whether the initial test input to the digital circuit manufactured according to the digital circuit design will cause the particular coverage point to be covered (step 506). For example, the network input can be generated from the initial test input and the particular coverage point as described above with reference to FIG. 4.

For example, the output of the prediction neural network can be a likelihood value, e.g., a value between 0 and 1, that represents a likelihood that the test would cover the coverage point.

The system updates the initial test input according to the prediction generated by the prediction neural network (step 508). In particular, the system can determine a difference between the generated prediction and a “desired” prediction that indicates the initial test would cover the coverage point. For example, if the prediction neural network is configured to generate a likelihood value as described above, then the desired prediction can be an output of 1.

The goal of the system is to identify a new test input that, when a corresponding network input is processed by the prediction neural network, causes the prediction neural network to output the desired prediction that the test would cover the particular coverage point (e.g., causes the prediction neural network to generate an output of 1).

The system can treat the determined difference as an “error” of the prediction neural network, and backpropagate the difference through the prediction neural network. However, instead of updating the parameter values of the prediction neural network, the system can leave the parameter values constant and update the component of the network input representing the initial test (e.g., the second network input described above with reference to FIG. 4). For example, the system can update the component of the network input that represents the initial test using gradient descent or gradient ascent to generate an updated network input.

The updated network input represents an updated test input that is closer to covering the particular coverage point than the initial test. The system can recover the updated test input from the updated network input. For example, in implementations in which the updated network input is a concatenation of (i) a first network input representation the particular coverage point and (ii) a second network input representing the updated test input, as described above with reference to FIG. 4, the system can remove the first network input from the concatenation to recover the second network input. The remaining second network input can then include a respective value for each parameter of the updated test input, as described above with reference to FIG. 4.

The system can repeat steps 506 and 508 multiple times to repeatedly update the current test input until identifying a new test input that is predicted to successfully cover the particular coverage point. For example, the system can repeat steps 506 and 508 until the likelihood value generated by the prediction neural network is greater than a threshold value, e.g., 0.5, 0.9, or 0.99.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method of generating a learned representation of a digital circuit design, the method comprising:
obtaining data representing a program that implements the digital circuit design, the program comprising a plurality of statements;
processing the obtained data to generate data representing a graph representing the digital circuit design, the graph comprising:
   a plurality of nodes representing respective statements of the program,
   a plurality of first edges, wherein each first edge is between a respective pair of nodes of the plurality of nodes and represents a control flow between a pair of statements of the program that are represented by the respective pair of nodes, and
   a plurality of second edges, wherein each second edge is between a respective pair of nodes of the plurality of nodes and represents a data flow between a pair of statements of the program that are represented by the respective pair of nodes; and
generating the learned representation of the digital circuit design, comprising processing the data representing the graph using a graph neural network to generate a respective learned representation of each statement represented by a node of the graph.

Embodiment 2 is the method of embodiment 1, further comprising:
processing, using a prediction neural network, a network input generated from the learned representation of the digital circuit design to generate a prediction about the digital circuit design.

Embodiment 3 is the method of embodiment 2, wherein the prediction is directed to a verification task of the digital circuit design.

Embodiment 4 is the method of embodiment 3, wherein the prediction about the digital circuit design comprises a prediction of whether a particular input to a digital circuit manufactured according to the digital circuit design will cause a particular coverage point to be covered.

Embodiment 5 is the method of embodiment 4, wherein the network input comprises:
a first network input representing the particular coverage point, and
a second network input representing the particular test.

Embodiment 6 is the method of embodiment 5, wherein processing, using the prediction neural network, the network input to generate the prediction comprises:
concatenating the first network input and the second network input to generate a concatenated network input; and
processing the concatenated network input using one or more feedforward neural network layers.

Embodiment 7 is the method of any one of embodiments 5 or 6, wherein:
the particular coverage point is defined by a subset of the plurality of statements; and
the first network input has been generated by performing operations comprising:
   obtaining the respective learned representation of each statement in the subset, and
   combining the obtained learned representations to generate the first network input.

Embodiment 8 is the method of embodiment 7, wherein obtaining the respective learned representation of each statement in the subset comprises:
obtaining representation data characterizing the respective learned representation for each statement of the plurality of statements;
generating a bitmask for the representation data, wherein the bitmask masks out each learned representation except for the respective learned representations of each statement in the subset; and
applying the bitmask to the representation data.

Embodiment 9 is the method of any one of embodiments 7 or 8, wherein combining the obtained learned representations comprises processing the obtained learned representations using a recurrent neural network.

Embodiment 10 is the method of any one of embodiments 5-9, wherein the second network input has been generated by performing operations comprising:
obtaining second data characterizing the particular test, the second data comprising a respective value for each of a plurality of predetermined variables of the particular test; and
processing the second data using one or more feedforward neural network layers.

Embodiment 11 is the method of any one of embodiments 2-10, wherein the prediction about the digital circuit design comprises an identity of a new test that is predicted to cover a desired coverage point.

Embodiment 12 is the method of embodiment 11, wherein the new test has been generated by performing operations comprising:
processing, using the prediction neural network, an initial network input characterizing an initial test;
determining, using a network output generated by the prediction neural network in response to processing the initial network input, whether the initial test would cover the desired coverage point;
determining a difference between (i) the network output and (ii) a desired network output that indicates that the initial test would cover the desired coverage point; and
backpropagating the determined difference through the prediction neural network to determine an update to the initial network input.

Embodiment 13 is the method of any one of embodiments 1-12, further comprising generating, for each node in the graph that represents a statement, an initial embedding for the node, comprising:
obtaining third data characterizing a plurality of attributes of the node;
obtaining a sequence of tokens representing the statement represented by the node; and
processing (i) the third data and (ii) the sequence of tokens to generate the initial embedding for the node.

Embodiment 14 is the method of embodiment 13, wherein processing (i) the third data and (ii) the sequence of tokens to generate the initial embedding for the node comprises:
processing the sequence of tokens using a recurrent neural network to generate a combined representation of the sequence; and
concatenating (i) the combined representation of the sequence and (ii) the third data to generate the initial embedding.

Embodiment 15 is a system comprising one or more computers and one or more storage devices storing instructions that when executed by the one or more computers cause the one more computers to perform the operations of the respective method of any one of embodiments 1-14.

Embodiment 16 is one or more computer storage media storing instructions that when executed by one or more computers cause the one more computers to perform the operations of the respective method of any one of embodiments 1-14.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of generating a learned representation of a digital circuit design, the method comprising:
obtaining data representing a program that implements the digital circuit design, the program comprising a plurality of statements;
processing the obtained data to generate data representing a graph representing the digital circuit design, the graph comprising:
a plurality of nodes representing respective statements of the program,
a plurality of first edges, wherein each first edge is between a respective pair of nodes of the plurality of nodes and represents a control flow between a pair of statements of the program that are represented by the respective pair of nodes, and
a plurality of second edges, wherein each second edge is between a respective pair of nodes of the plurality of nodes and represents a data flow between a pair of statements of the program that are represented by the respective pair of nodes; and
generating the learned representation of the digital circuit design, comprising processing the data representing the graph using a graph neural network to generate a respective learned representation of each statement represented by a node of the graph.

2. The method of claim 1, further comprising:
processing, using a prediction neural network, a network input generated from the learned representation of the digital circuit design to generate a prediction about the digital circuit design.

3. The method of claim 2, wherein the prediction is directed to a hardware verification task of the digital circuit design.

4. The method of claim 3, wherein the prediction about the digital circuit design comprises a prediction of whether a particular input to a digital circuit manufactured according to the digital circuit design will cause a particular coverage point to be covered.

5. The method of claim 4, wherein the network input comprises:
a first network input representing the particular coverage point, and
a second network input representing the particular test.

6. The method of claim 5, wherein processing, using the prediction neural network, the network input to generate the prediction comprises:
concatenating the first network input and the second network input to generate a concatenated network input; and
processing the concatenated network input using one or more feedforward neural network layers.

7. The method of claim 5, wherein:
the particular coverage point is defined by a subset of the plurality of statements; and
the first network input has been generated by performing operations comprising:
obtaining the respective learned representation of each statement in the subset, and
combining the obtained learned representations to generate the first network input.

8. The method of claim 7, wherein obtaining the respective learned representation of each statement in the subset comprises:
obtaining representation data characterizing the respective learned representation for each statement of the plurality of statements;
generating a bitmask for the representation data, wherein the bitmask masks out each learned representation except for the respective learned representations of each statement in the subset; and
applying the bitmask to the representation data.

9. The method of claim 7, wherein combining the obtained learned representations comprises processing the obtained learned representations using a recurrent neural network.

10. The method of claim 5, wherein the second network input has been generated by performing operations comprising:
obtaining second data characterizing the particular test, the second data comprising a respective value for each of a plurality of predetermined variables of the particular test; and
processing the second data using one or more feedforward neural network layers.

11. The method of claim 2, wherein the prediction about the digital circuit design comprises an identity of a new test that is predicted to cover a desired coverage point.

12. The method of claim 11, wherein the new test has been generated by performing operations comprising:
processing, using the prediction neural network, an initial network input characterizing an initial test;
determining, using a network output generated by the prediction neural network in response to processing the initial network input, whether the initial test would cover the desired coverage point;
determining a difference between (i) the network output and (ii) a desired network output that indicates that the initial test would cover the desired coverage point; and
backpropagating the determined difference through the prediction neural network to determine an update to the initial network input.

13. The method of claim 2, further comprising manufacturing digital circuit hardware dependent on the prediction.

14. The method of claim 1, further comprising generating, for each node in the graph that represents a statement, an initial embedding for the node, comprising:
obtaining third data characterizing a plurality of attributes of the node;
obtaining a sequence of tokens representing the statement represented by the node; and
processing (i) the third data and (ii) the sequence of tokens to generate the initial embedding for the node.

15. The method of claim 14, wherein processing (i) the third data and (ii) the sequence of tokens to generate the initial embedding for the node comprises:
processing the sequence of tokens using a recurrent neural network to generate a combined representation of the sequence; and
concatenating (i) the combined representation of the sequence and (ii) the third data to generate the initial embedding.

16. The method of claim 1, further comprising manufacturing digital circuit hardware in accordance with the design.

17. A system comprising one or more computers and one or more storage devices storing instructions that when executed by the one or more computers cause the one more computers to perform operations for generating a learned representation of a digital circuit design, the operations comprising:
obtaining data representing a program that implements the digital circuit design, the program comprising a plurality of statements;
processing the obtained data to generate data representing a graph representing the digital circuit design, the graph comprising:
a plurality of nodes representing respective statements of the program,
a plurality of first edges, wherein each first edge is between a respective pair of nodes of the plurality of nodes and represents a control flow between a pair of statements of the program that are represented by the respective pair of nodes, and
a plurality of second edges, wherein each second edge is between a respective pair of nodes of the plurality of nodes and represents a data flow between a pair of statements of the program that are represented by the respective pair of nodes; and
generating the learned representation of the digital circuit design, comprising processing the data representing the graph using a graph neural network to generate a respective learned representation of each statement represented by a node of the graph.

18. (canceled)

19. The system of claim 17, the operations further comprising:
processing, using a prediction neural network, a network input generated from the learned representation of the digital circuit design to generate a prediction about the digital circuit design.

20. The system of claim 19, wherein the prediction is directed to a hardware verification task of the digital circuit design.

21. One or more non-transitory computer-readable storage media storing instructions that when executed by one or more computers cause the one more computers to perform operations for generating a learned representation of a digital circuit design, the operations comprising:
obtaining data representing a program that implements the digital circuit design, the program comprising a plurality of statements;
processing the obtained data to generate data representing a graph representing the digital circuit design, the graph comprising:
a plurality of nodes representing respective statements of the program,
a plurality of first edges, wherein each first edge is between a respective pair of nodes of the plurality of nodes and represents a control flow between a pair of statements of the program that are represented by the respective pair of nodes, and
a plurality of second edges, wherein each second edge is between a respective pair of nodes of the plurality of nodes and represents a data flow between a pair of statements of the program that are represented by the respective pair of nodes; and
generating the learned representation of the digital circuit design, comprising processing the data representing the graph using a graph neural network to generate a respective learned representation of each statement represented by a node of the graph.
